(19) United States
(12) Patent Application Publication
(10) Pub. No.: US 2021/0274709 A1
(43) Pub. Date: Sep. 9, 2021

(54) Attachment for a Walk-Behind Lawnmower

(71) Applicant: Robert Sitarz, Oakbank (CA)

(72) Inventor: Robert Sitarz, Oakbank (CA)

(21) Appl. No.: 17/185,036

(22) Filed: Feb. 25, 2021

Related U.S. Application Data
(60) Provisional application No. 62/984,601, filed on Mar. 3, 2020.

(51) Int. Cl. A01D 34/82; A01D 34/81; A01D 34/67; A01D 101/00

(52) U.S. Cl. CPC A01D 34/828; A01D 2101/00; A01D 34/67; A01D 34/81

(57) ABSTRACT

An attachment is provided for a walk-behind lawnmower for use in protecting shrubs, plants and flowers & extension cords or other items in a lawn as it is mowed and includes a guard bar mounted on the lawnmower by a mounting assembly so as to extend along the side of the housing at a position above the front and rear wheels on that side. The guard bar further includes a downwardly turned front end portion with a front tip which is located in front of the housing at the ground to run at or just above the ground as the housing is moved forwardly. The front end portion includes an upwards curled tip and lies in a common vertical plane with the main portion along the side. An additional rear bar portion extends upwardly and rearwardly along one side rail of the handle from the rear end of the bar.

This application claims the benefit under 35 USC 119 (e) of Provisional application 62/984,601 filed Mar. 3, 2020.

This invention relates to an attachment for a walk behind lawnmower which acts to protects shrubs, plants and flowers & extension cords or other items in lawns.

### SUMMARY OF THE INVENTION

According to the invention there is provided a attachment for a walk-behind lawnmower for use in protecting shrubs, plants and flowers & extension cords or other items in a lawn as it is mowed,

wherein the lawnmower comprises a cutter housing, a guiding handle extending upwardly and rearwardly from the housing and four rotatable ground wheels with a front wheel and a rear wheel on a first side and two wheels on a second side,

the attachment comprising:

a guard bar mounted on the lawnmower by a mounting assembly so as to extend along said first side of the housing at a position above the front and rear wheels on said first side;

the guard bar including a first portion extending along said first side of the housing to a front end of the guard bar located at said first side in front of the housing and to a rear end at or adjacent the rear wheel;

the guard bar including a downwardly turned front end portion with a front tip which is located in front of the housing at the ground to run at or just above the ground as the housing is moved forwardly.

Preferably in one embodiment the guard bar comprises a horizontal portion and said front end portion which has a bend downwards beginning just ahead of the front wheel.

Preferably in one embodiment the front end portion is bent to a horizontal orientation.

Preferably in one embodiment the front end portion includes an upwards curled tip.

Preferably in one embodiment the front end portion lies in a common vertical plane with the first portion.

Preferably in one embodiment there is provided a rear bar portion extending upwardly and rearwardly from the rear end of the first portion.

Preferably in one embodiment the rear bar portion is attached to the handle at said first side.

Preferably in one embodiment the rear bar portion is attached to the handle by a pivot coupling which allows the rear bar portion to pivot relative to the handle as the handles is moved.

Preferably in one embodiment the rear bar portion includes a front end attached to a bracket on the housing at a pivot location of the handle.

Preferably in one embodiment the rear end of the first portion of the guard bar is attached to a rear bracket connected to the housing at a pivot location of the handle.

Preferably in one embodiment the rear bracket connected to the housing includes a horizontal plate onto which the first portion of the guard bar is attached.

Preferably in one embodiment the front end of the first portion of the guard bar is attached to a front bracket connected to the housing at a front face of the housing inwardly of the front wheel.

Preferably in one embodiment the front bracket includes a horizontal plate onto which the first portion of the guard bar is attached.

Preferably in one embodiment the front bracket is adjustable so as to move the horizontal plate onto which the first portion of the guard bar is attached both vertically and horizontally relative to the housing.

Preferably in one embodiment the attachment is mounted opposite the discharge chute of the mower.

Preferably in one embodiment the attachment does not interfere with the height adjustment mechanisms of the mower.

The attachment operates to lift things out of the way without having to move things manually or secure them out of the way as grass is mowed allowing for as close a cut as possible to shrubs, plants and flowers without the need for a string trimmer (e.g. weedeater).

In one alternative arrangement, the first portion of the guard bar is mounted on first and second upstanding legs each arranged for mounting on a respective support axle member of one side of the housing so as to stand upwardly therefrom to a position on said one side of the housing. Each of the legs can include a hole at the lower end to mount to where the wheel is secured to the housing or directly to the housing itself. Each of the legs can have a 90° bend defining a horizontal portion extending outwardly from the leg to the side of the housing with the guard bar attached to the outer end of the portion.

The invention provides an attachment for walk-behind lawnmowers, and serves to prevent damage to plants, flowers, shrubs and anything else that may have low hanging extensions that encroach onto lawn areas whose grass is cut by means of a walk-behind lawnmower. These areas can be extremely challenging to mow without damaging branches, flowers, fruits, vegetables etc. as the lawnmower wheel(s) will have tendency to run over whatever is extending into the lawn area, thus subjecting it to the lawnmower blades below and potentially damaging it. The attachment allows for these low hanging extensions to be lifted up as the lawnmower is pushed through and cuts the grass beneath. They then drop back to their original position as the lawnmower passes and continues on. The attachment will also serve another function. Because the front end of it rides just above the ground—through the grass blades, ahead of the lawnmower, it will also pick up anything that may be lying in the grass before the lawnmower runs over it (e.g. extension cord, a kids' toy like a skipping rope, garden hose etc.). This can be particularly important especially in the event of a “live” extension cord.

The attachment is made of steel and typically may be 1″ in width and ⅛″ in thickness. It is comprised of a horizontal piece which has a bend downwards at an approximate 45° angle beginning just ahead of the front wheel, and then bent to a horizontal orientation again ending with a slight upwards curl. Attached to the horizontal length are two brackets made of the same material.

The brackets can be mounted by different arrangements to the mower. These can provide adjustment of the height and horizontal position of the guard bar.

In one arrangement, each bracket extends perpendicular to the horizontal length, and then has a 90° bend and extend downwards where there is a hole at the end to mount to where the wheel is secured to the mower body, or directly to the mower body itself.

This attachment is mounted opposite the discharge chute of the mower. The attachment does not interfere with the height adjustment mechanisms of the mower, nor does it affect the lawnmower's performance in any way. It is simply designed to lift things out of the way without having to move things manually or secure them out of the way as grass is mowed in the affected areas underneath them.

### BRIEF DESCRIPTION OF THE DRAWINGS

One embodiment of the invention will now be described in conjunction with the accompanying drawings in which:

FIG. 1 is an exploded view showing a lawnmower and one embodiment of attachment according to the present invention.

FIG. 2 is an isometric view of the attachment of FIG. 1.

FIG. 3 is an isometric view of the attachment attached to the lawnmower and including an additional guard component which extends upwardly and rearwardly from the rear end of the main portion of the guard bar.

FIG. 4 is an isometric view of a second embodiment of the attachment including the additional guard component of FIG. 3 which extends upwardly and rearwardly from the rear end of the main portion of the guard bar and including an alternative mounting arrangement for attachment to the body of the mower rather than the wheels.

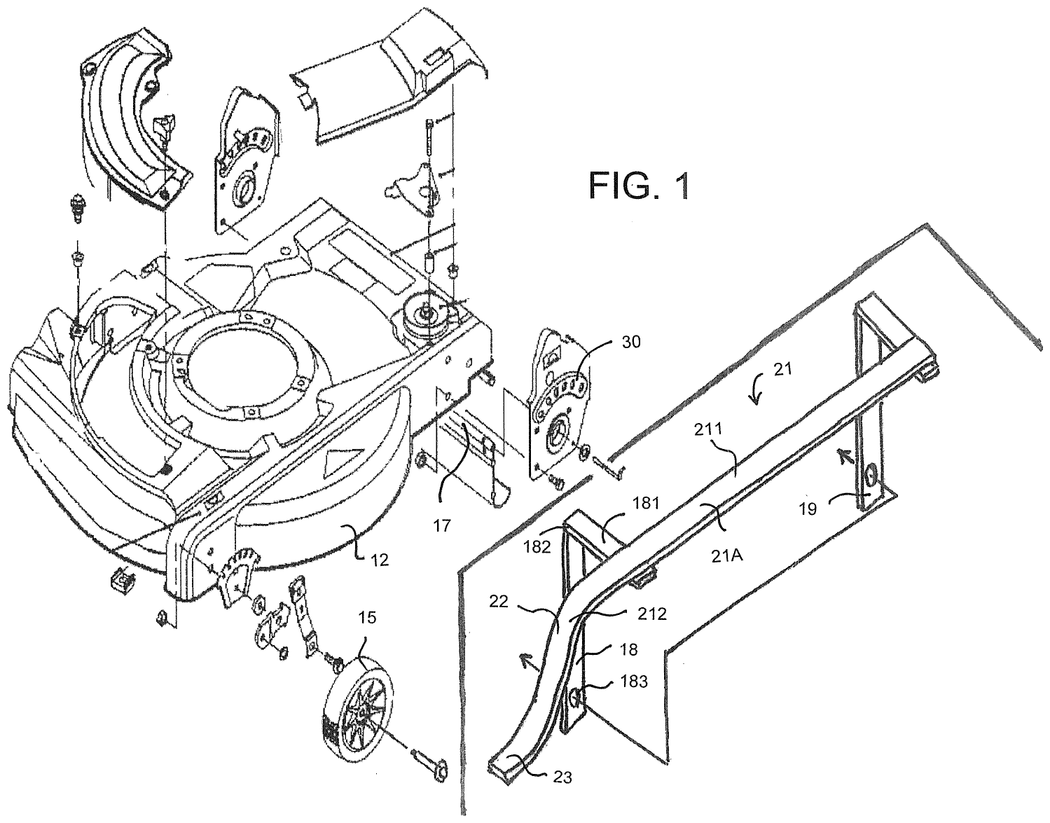

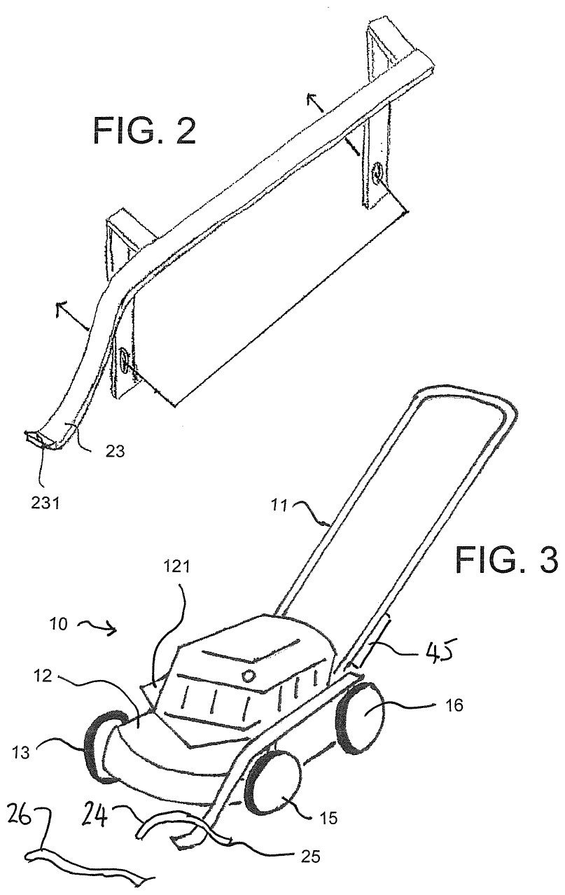

In the drawings like characters of reference indicate corresponding parts in the different figures.

### DETAILED DESCRIPTION

The attachment for a walk-behind lawnmower 10 which can be self-propelled or manually pushed by the handle 11, comprises a cutter housing 12, a guiding handle 11 extending upwardly and rearwardly from the housing and four rotatable ground wheels 13, 14, 15 and 16 with two wheels on each side each carried on wheel support axle member 17.

The attachment comprises first and second upstanding legs 18, 19 each arranged for mounting on a respective support axle member of one side of the housing or directly on the housing so as to stand upwardly therefrom to a position on the side of the housing opposite the discharge 20.

The attachment includes a guard bar 21 attached to the top of the legs 18, 19 so as to extend along said side of the housing to a front end of the guard bar located at the side in front of the housing.

The guard bar 21 includes a main horizontal portion 21A extending along the top of the wheels and a downwardly turned front end portion 22 with a front tip 23 which is located in front of the housing 10 at the ground to run at or just above the ground as the housing is moved forwardly.

The guard bar and particularly the front tip 23 serves to prevent damage to plants, flowers, shrubs and anything else that may have low hanging extensions that encroach onto lawn areas whose grass is cut by means of a walk-behind lawnmower. The attachment allows for these low hanging extensions 24 of adjacent plants 25 to be lifted up as the lawnmower is pushed through and cuts the grass beneath. They then drop back to their original position as the lawnmower passes and continues on. The front end of it rides just above the ground and acts to pick up items 26 that may be lying in the grass before the lawnmower runs over it.

The attachment includes a horizontal piece 211 which has a bend 212 downwards at an approximate 45° angle beginning just ahead of the front wheel 15, and then bent to a horizontal orientation at tip 23 again ending with a slight upwards curl 231. Attached to the horizontal length are two brackets 18, 19 made of the same material. They each extend in a first portion 181 perpendicular to the horizontal length, and then have a 90° bend 182 and extend downwards where there is a hole 183 at the end to mount to where the wheel is secured to the mower body, or directly to the mower body itself. This attachment is mounted opposite the discharge chute 121 of the mower. The attachment does not interfere with the height adjustment mechanisms 30 of the mower, nor does it affect the lawnmower's performance in any way. It is simply designed to lift things out of the way without having to move things manually or secure them out of the way as grass is mowed in the affected areas underneath them.

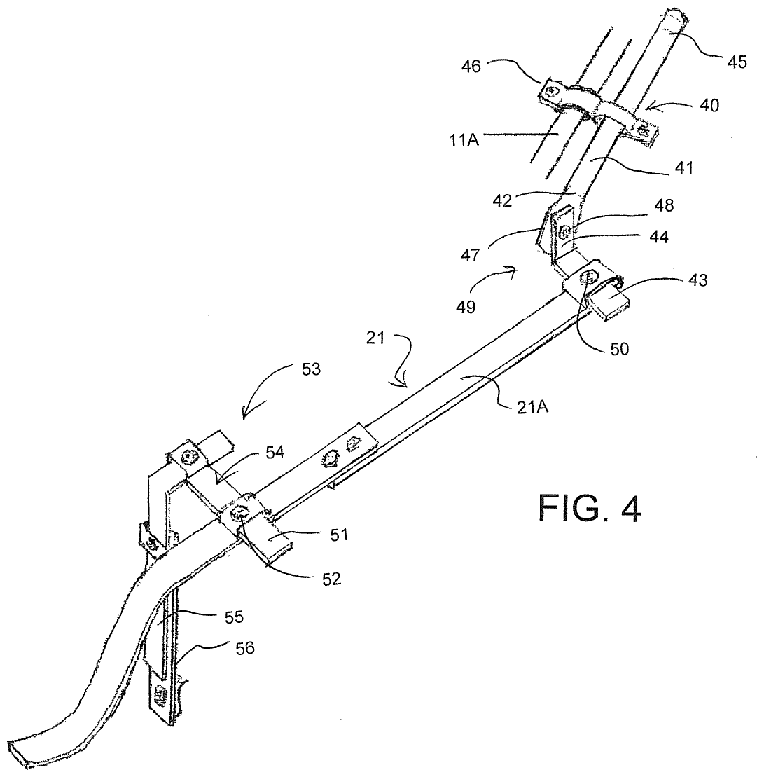

Turning now to FIGS. 3 and 4, there is provided a rear bar portion 40 extending upwardly and rearwardly from the rear end of the first main portion 21A of the guard bar 211. The bar portion 40 includes a tube 41 with a flattened front flange 42 which is attached to the bracket 43 at the upstanding attachment flange 44. The tube 41 extends rearwardly to a rear end 45 part way along the side rail of the handle. The bar is supported at a position behind the flange 44 by a pivot coupling 46 which attaches to the side rail 11A of the handle 11. The rear bar portion is thus attached to the handle at the first side and is attached to the handle by the pivot coupling 46 which allows the rear bar portion to pivot relative to the handle as the handle is moved.

The rear bar portion 40 includes a front end 47 attached to the flange 44 of the bracket 43 which is itself connected to the housing at a bolt 48 forming a pivot location of the handle. Thus the bracket 43 can be attached to the housing simply by removing the bolt 48, inserting the flange 44 and reattaching the bolt. This then holds the plate on which the guard bar is mounted in horizontal position extending outwardly from the mower housing.

The rear bracket 49 connected to the housing thus includes the horizontal plate 43 onto which the first portion 21A of the guard bar 21 is attached by a bolt 50.

This mounting arrangement is advantageous relative to the wheel mounting system since it is more universal and can couple to different makes, models and types of lawnmowers.

At the front end of the first portion 21A of the guard bar 21, the flat bar is attached to a horizontal flange 51 of a front bracket 53 by a bolt 52. The flange 51 is connected to the housing 12 at a front face of the housing 12 inwardly of the front wheel.

The front bracket 53 includes a horizontal plate 51 onto which the first portion 21A of the guard bar 21 is attached. The front bracket includes a clamp 56 which attaches to the mower housing and slide components 54 and 55 which make it adjustable relative to the clamp 56 so as to move the horizontal plate 51 both vertically and horizontally relative to the housing.

The attachment is mounted opposite the discharge chute of the mower. The attachment does not interfere with the height adjustment mechanisms of the mower. The attachment operates to lift things out of the way without having to move things manually or secure them out of the way as grass is mowed.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An attachment for a walk-behind lawnmower for use in protecting shrubs, plants and flowers & extension cords or other items in a lawn as it is mowed,
wherein the lawnmower comprises a cutter housing, a guiding handle extending upwardly and rearwardly from the housing and four rotatable ground wheels with a front wheel and a rear wheel on a first side and two wheels on a second side,
the attachment comprising:
a guard bar mounted on the lawnmower by a mounting assembly so as to extend along said first side of the housing at a position above the front and rear wheels on said first side;
the guard bar including a first portion extending along said first side of the housing to a front end of the guard bar located at said first side in front of the housing and to a rear end at or adjacent the rear wheel;
the guard bar including a downwardly turned front end portion with a front tip which is located in front of the housing at the ground to run at or just above the ground as the housing is moved forwardly.

2. The attachment according to claim 1 wherein the guard bar comprises a horizontal portion and said front end portion which has a bend downwards beginning just ahead of the front wheel.

3. The attachment according to claim 1 wherein the front end portion is bent to a horizontal orientation.

4. The attachment according to claim 1 wherein the front end portion includes an upwards curled tip.

5. The attachment according to claim 1 wherein the front end portion lies in a common vertical plane with the first portion.

6. The attachment according to claim 1 wherein there is provided a rear bar portion extending upwardly and rearwardly from the rear end of the first portion.

7. The attachment according to claim 1 wherein the rear bar portion is attached to the handle at said first side.

8. The attachment according to claim 1 wherein the rear bar portion is attached to the handle by a pivot coupling which allows the rear bar portion to pivot relative to the handle as the handles is moved.

9. The attachment according to claim 1 wherein the rear bar portion includes a front end attached to a bracket on the housing at a pivot location of the handle.

10. The attachment according to claim 1 wherein the rear end of the first portion of the guard bar is attached to a rear bracket connected to the housing at a pivot location of the handle.

11. The attachment according to claim 1 wherein the rear bracket connected to the housing includes a horizontal plate onto which the first portion of the guard bar is attached.

12. The attachment according to claim 1 wherein the front end of the first portion of the guard bar is attached to a front bracket connected to the housing at a front face of the housing inwardly of the front wheel.

13. The attachment according to claim 1 wherein the front bracket includes a horizontal plate onto which the first portion of the guard bar is attached.

14. The attachment according to claim 1 wherein the front bracket is adjustable so as to move the horizontal plate onto which the first portion of the guard bar is attached both vertically and horizontally relative to the housing.

15. The attachment according to claim 1 wherein the attachment is mounted opposite the discharge chute of the mower.

16. The attachment according to claim 1 wherein the attachment does not interfere with the height adjustment mechanisms of the mower.

17. The attachment according to claim 1 wherein the attachment operates to lift things out of the way without having to move things manually or secure them out of the way as grass is mowed.

18. The attachment according to claim 1 wherein the first portion of the guard bar is mounted on first and second upstanding legs each arranged for mounting on a respective support axle member of one side of the housing so as to stand upwardly therefrom to a position on said one side of the housing;

19. The attachment according to claim 18 wherein each of the legs includes a hole at the lower end to mount to where the wheel is secured to the housing or directly to the housing itself.

20. The attachment according to claim 18 wherein each of the legs has a 90° bend defining a horizontal portion extending outwardly from the leg to the side of the housing with the guard bar attached to the outer end of the portion.
